(19) United States
(12) Patent Application Publication
(10) Pub. No.: US 2024/0027182 A1
(43) Pub. Date: Jan. 25, 2024

(54) THZ MEASURING DEVICE AND THZ MEASURING METHOD FOR PERFORMING A MEASUREMENT ON A CORRUGATED PIPE

(71) Applicant: CiTEX Holding GmbH, Melle (DE)

(72) Inventors: Arno NEUMEISTER, Porta Westfalica (DE); Jan Hendrik PETERMANN, Melle (DE)

(21) Appl. No.: 18/257,466

(22) PCT Filed: Dec. 15, 2021
(86) PCT No.: PCT/DE2021/101006

§ 371 Date: Jun. 14, 2023

(30) Foreign Application Priority Data
Dec. 16, 2020 (DE) 102020133704.3

(51) Int. Cl. G01B 11/02; G01B 11/06; G01B 11/08

(52) U.S. Cl. CPC G01B 11/026; G01B 11/06; G01B 11/08

(57) ABSTRACT

The invention relates to a THZ measuring device and a THz measuring method for measuring a corrugated pipe (1).

Hereby, a corrugated pipe (1) comprising waves (2) and troughs (3) formed in-between the waves (2), e.g., also fittings (7) and exterior sleeves (6), is guided in a transport direction (z) through a measuring plane (37) in a measuring space of the THz measuring device (20).

In a pre-measurement, e.g., using a detecting means, e.g., with a laser, a Position or a distance of an exterior surface (8) of the corrugated pipe (1) is continuously determined, subsequently this is used to determine a structure (2, 3, 6, 7) of the corrugated pipe (1) in the measuring plane (37), and a focal point (27) of a THz transceiver (22) along its optical axis (C) is optionally adjusted to a measuring distance (MT) depending on the determined structure (2, 3, 6, 7) of the corrugated pipe (1) in the measuring plane (37). Subsequently or in parallel a THz measurement is carried out involving emission of a THz transmission beam along the optical axis, focusing on the focal point and detection of a reflected THz beam (26) and a determination of at least one distance of a boundary surface or a layer thickness from the THz measurement.

The invention relates to a THz measuring device and a THz measuring method for measuring a corrugated pipe. Further, an arrangement and a method for manufacturing the corrugated pipe are provided.

Corrugated pipes made of plastics or other thermoplastic materials exhibit a structure of alternating waves and troughs, possibly including additional structures such as fittings (inner sleeves, spigots) and external sleeves (bells) and serve, in particular, in particular, for laying lines and cables and also for transporting fluids. Due to the corrugation the corrugated pipes are highly bendable and flexible while maintaining high stiffness against applied forces, in particular, loads transverse to its longitudinal axis. Corrugated pipes for transporting fluids generally include a continuous inner pipe so that an air chamber is formed between a wave (crest) and the inner pipe. The waves may be, in particular, circumferential in the circumferential direction; further, designs including helical or, respectively, spiral waves are known.

Manufacturing generally happens in that a plastic pipe is pre-fabricated from an extruder and shaped into the structures by means of a wave-forming corrugator. Subsequently, it may be provided to measure the corrugated pipe and its formed structures so as to detect leakage and weaknesses, e.g., shrinkage cavities in the plastics material and verify the layer thicknesses.

THz measuring processes generally allow for a contact-less measuring of distances, diameters and layer thicknesses in that a THz transmission beam passes through the pipe and is reflected boundary surfaces. To that end, generally, the THz transmission beam is focused onto a pipe axis of the pipe so as the allow for, e.g., measuring a front and rear wall area of the pipe.

Measuring corrugated pipes, however, is generally complex, because the structures are formed at different distances from the pipe axis and have surfaces parallel to the pipe axis only in certain parts.

The document DE 10 2016 114 325 A1 shows a method including the steps of scanning a first varnished surface of a first vehicle having two or more lacquer layers by means of a robot-controlled Terahertz radiator device, where date relating to the thickness of a first varnished surface are obtained and an image for each of the two or more lacquer layers is obtained. Further, the first formation of the thickness is compared to a reference image, and one or more lacquer applying parameters are adjusted based on a comparison of the thickness with the reference, for painting a second surface of a second vehicle.

The citation DE 10 2018 126 652 A1 shows a method and a system for aligning a Terahertz sensor system with a target surface. This method includes the steps of scanning a selected area of the target surface by means of a Terahertz beam bundle emitted by the radiator head, detecting a peak amplitude for each reflected radiation signal from a plurality of reflected radiation signals received by the radiator head during scanning of the selected area, and identifying a perpendicular position of the radiator head in relation to the target surface based on a maximum peak amplitude among the peak amplitudes of the reflected radiation signals.

The document EP 3 742 191 A1 describes a THz measuring device and a method of operating such a Terahertz measuring device. Hereby, a THz signal is emitted towards an object to be measured, and a part of the THz signal reflected from the object is received, the THz transmitter and the THz receiver being provided in a measuring head of the measuring device. In this measuring method a distance between the measuring head and the object to be measured is varied.

The citation DE 10 2015 122 205 A1 describes a THz measuring method and a Terahertz measuring device for determining a layer thickness or a distance of an object to be measured, wherein at last one Terahertz beam is irradiated from a Terahertz transmitter and receiver unit along an optical axis towards the measured object, and Terahertz radiation having passed through at least one layer of the measured object and having been reflected is detected. Hereby, a measuring signal of the detected reflected Terahertz radiation is evaluated and a layer thickness is determined, where a plurality of measurements at various optical distances are carried out.

From the document DE 10 2019 108 299 A1 a THz measuring device and a THz measuring method for determining a layer thickness or a distance of a measured object are known, wherein a transmitter and receiver unit emits Terahertz radiation, and reflected Terahertz radiation is detected. In the beam path an adjustable optics unit including a reflector is arranged which deflects the emitted and/or reflected Terahertz radiation, for adjusting the optical axis of the transmitter and receiver unit. Hereby, the reflector is designed to be deformable.

The document WO 2005/019810 A2 describes an inspection system including a focusing device, the inspection system emitting THz radiation through the focusing device, the focusing device comprising a focusing surface having an ellipsoidal shape.

The citation US 2018112973 A1 discloses a device for measuring the diameter and/or the wall thickness of a strand that has a substantially circular cross-section and is guided through the device. It includes at least one transmitter for transmitting terahertz radiation, at least one radiation optical system that conducts the terahertz radiation to a strand, at least one reflector for the terahertz radiation arranged opposite a transmitter and behind the strand in the radiation direction, at least one receiver for receiving the terahertz radiation reflected at the strand and/or the reflector, and an evaluation apparatus that determines the diameter and/or the wall thickness of the strand.

The document CN 11067254 A discloses an imaging method, wherein a first imaging position according to a three-dimensional position model of the measured object is adjusted to obtain a second imaging position, wherein the terahertz wave signal reflected by the measured object is acquired at the second imaging position, and a three-dimensional image reconstruction is performed based on the terahertz wave signal to obtain a three-dimensional image of the measured object.

The citation US 2016265901 A1 shows an apparatus for monitoring an extruded product moving in an inline extrusion process so as to effect quality control of the process by continuously measuring dimensional parameters and determining the existence of contaminants in the extrusion. The apparatus makes use of terahertz radiation which is adapted to provide a curtain of parallel rays of the radiation which is scanned across the product as the product passes therethrough in a linear manner. Afterwards an imaging analysis of the received radiation is used to determine the dimensional parameters of the moving products.

The invention is based on the object of creating a THz measuring method and a THz measuring device which allow secure measuring of a continuously passing corrugated pipe.

This task is solved by a THz measuring method and a THz measuring device according to the independent claims. The sub-claims describe preferred further developments.

The THz measuring method according to the invention can be carried out, in particular, using the THz measuring device according to the invention; the THz measuring device according to the invention is provided, in particular, for carrying out a THz measuring method according to the invention.

The THz transceiver may carry out a direct time-of-flight measurement, and/or a frequency modulation of the THz transmission beam, and/or be designed with a pulsed THz transmission beam. It may be, in particular, a frequency modulated continuous radar beam.

The frequency of the THz transmission beam may lie in the range between 10 GHz and 50 THz, in particular, 50 GHz and 10 THz. Thus, the THz radiation may also lie in the frequency range of microwave radiation and/or radar radiation.

The THz transceiver refers in principle to a combination of a THz transmitter (THz-Transmitter) and a THz receiver (THz-Receiver), These may be designed, in particular, as a physical unit, e.g., even as a combined oscillating circuit; however, in principle, they may also be arranged separately, e.g., with a coupling via a semi-transparent mirror.

Thus, according to the invention, what is carried out is a THz measuring of a corrugated pipe, in particular, a corrugated pipe continuously transported through the THz measuring device. Hereby, it is provided to carry out a measurement using a detecting means, wherein a position or a distance or an exterior surface of the corrugated pipe is detected. The detecting means may be a distance sensor. Hereby, the distance sensor may be, in particular, a laser measuring device or a lidar respectively for measuring the position, in particular, as a line laser or distance laser, but also a radar, in particular, a frequency modulated continuous wave radar (FMCW).

Hereby, the invention recognizes that, using such a detecting means, already upon determination of merely the exterior surface of the corrugated pipe, it is possible to establish a clear allocation and detection of the structural position, i.e. a wave, a trough or another structure such as a fitting (inner sleeve) or outer sleeve.

According to the invention, it is possible, after determining the structure or structural position, to align the THz measurement towards the prior recognized structure and/or allocate the determined layer thicknesses and/or wall thicknesses and/or diameters to the respective structure of the corrugated pipe.

According to an embodiment, a fixed focusing may be provided for the various measurements. Thus, it is possible to configure the focus of the sensors and/or the focus of the sensors and the optical arrangement can be configured to a fixed value, in particular, a nominal diameter of a smallest corrugated pipe intended for the measuring device, so that, in particular, the sensors remain at a fixed distance to the axis of symmetry of the measuring space. There, owing to the focusing on the smallest pipe, the focal point will be the smallest. This is of advantage because, generally, the smallest pipe will also have the smallest structures (waves/troughs). If, on the other hand, the focal point is too large, it is possible for a plurality of structures to be detected in a single measurement potentially leading to technical measurement problems.

According to an embodiment alternative hereto, the focusing is changed. Hereby, preferably, the THz transmission beam is focused onto a focal point which is adjusted at a measuring distance relative to the pipe axis or axis of symmetry. Hereby, preferably, the measuring distance is adjusted depending on the prior recognized structural position. Thus, advantageously, a focusing onto the pipe axis is not provided, as it is provided generally in conventional es THz measuring processes for a pipe or non-corrugated pipe, but a purposeful adjustment of the focal point to structures of the corrugated pipe. Thus, the THz transmission beam may be focused, e.g., on an exterior wall of a wave and subsequently to the inner wall of the wave; in the case of a trough the THz transmission beam may be focused directly on the trough which, e.g., may even correspond to the inner pipe. In the case of other structures one or more measuring distance may be set accordingly.

For focusing the THz transmission beam and for receiving the reflected beam, preferably, an optical arrangement, in particular, including a lens, is provided in front of the transceiver, in particular, the transceiver chip.

According to the invention, focusing is carried out, in particular, by longitudinally adjusting the THz transceiver, in particular, the THz transceiver arrangement of including the optical arrangement. Thus, in particular, what is adjusted is not, e.g., the lens in relation to the transceiver or transceiver chip, but the arrangement consisting of THz transceiver and lens or, respectively, optical arrangement remains fixed relative to one another, and is adjusted towards and away from the measuring space because, according to the invention, this leads to an improved and more accurate focusing.

According to the invention, it is recognized that focusing on the pie axis is a problem also because of the structures since the THz beam to be focused is influenced differently in the various positions by the different structures of the corrugated pipe, e.g., likewise on edges and surfaces that extend perpendicular on angular. Thus, the focusing on different measuring distances, which may initially appear complex, allows for a more accurate measuring.

The THz measuring allows distances and/or layer thicknesses to be determined each, in particular, one or more of the following dimensions: an exterior diameter and/or interior diameter of a structure such as, e.g., a wave or even an inner tube, layer thicknesses of all layers and surfaces, i.e., in particular, an exterior wall of a wave, an inner wall of a wave, an inner tube and/or a trough, the layer thickness of an air gap between the exterior wall of the wave and the inner wall or the inner tube.

According to the invention, it is further possible to determine additional characteristic values from the direct measurement data, e.g., indirectly calculated and/or statistical values such as an inner roughness, resulting from the differences of the inner diameter or inner pipe on the various structure areas, i.e., in particular, on the waves and troughs, where the inner roughness, e.g., affects the transport of fluids.

According to the invention, one or more THz transceivers may be provided, e.g., a plurality of THz transceivers arranged in the circumferential direction around the measuring space or, respectively, the corrugated pipe. Besides a static arrangement, where measurements are taken at one or more spots in the circumference, it is also possible, in particular, to move or more THz transceivers reversing or rotating around the measured pipe so as to allow for a measurement of the full circumference.

Since measuring the corrugated pipe is relatively time-consuming, in particular, in the case of reversing circulation and when focusing on different radial positions of the structures, for measuring a passing though corrugated pipe a cyclic longitudinal adjustment of the THz transceivers may be provided. Hereby, in particular, a slide is provided which is adjusted along in the longitudinal direction or, respectively, transport direction of the corrugated pipe thereby allowing for a fixed or relatively fixed relative position of the THz transceivers in relation to the corrugated pipe so that the relatively time-consuming measurements are made possible.

According to the invention, in particular, an improved method for manufacturing corrugated pipes is created allowing for a continuous online measuring, where, when deviations are detected, a direct manipulation of the production process is possible, in particular, by controlling the extruder and/or the corrugator.

Advantageously, when using a laser, the detecting means deflect the laser beam cyclically or, respectively, periodically, in particular, pivoting from the purely radial direction in the longitudinal direction so as to better scan the structures of the corrugated pipe, i.e., troughs and waves. Thus, the angular path of the laser beam also allows, e.g., a detection of the lateral surfaces of the waves and fittings which have no surfaces extending perpendicular to the THz beam.

Hereby, a quick pivoting movement or rotation of the laser beam at a high speed of adjustment or, respectively, rotation relative to the transport velocity of the corrugated pipe may be provided so that thorough measurements of the various structures are possible. Hereby, the invention recognizes that this can be achieved with relatively little expenditure and high measuring certainty by means of, e.g., a firmly attached detector head which emits a laser beam onto an adjustable, e.g., rotating mirror.

The corrugated pipe may, in particular, be transported continuously through the measuring device and be measured in the measuring device.

Determining the distances and layer thicknesses and of indirectly derived characteristic values such as the roughness as well as possibly a comparison with reference values may happen online or, respectively, during the measurement, but also offline, i.e., independent of the measurement.

In a manufacturing process of the corrugated pipe, in particular, the measuring and evaluation may happen online so as to control the extruder and/or the corrugator depending on the evaluation, i.e., to create a control method.

The invention is illustrated below by means of the attached drawings by means of a few embodiments. It is shown in:

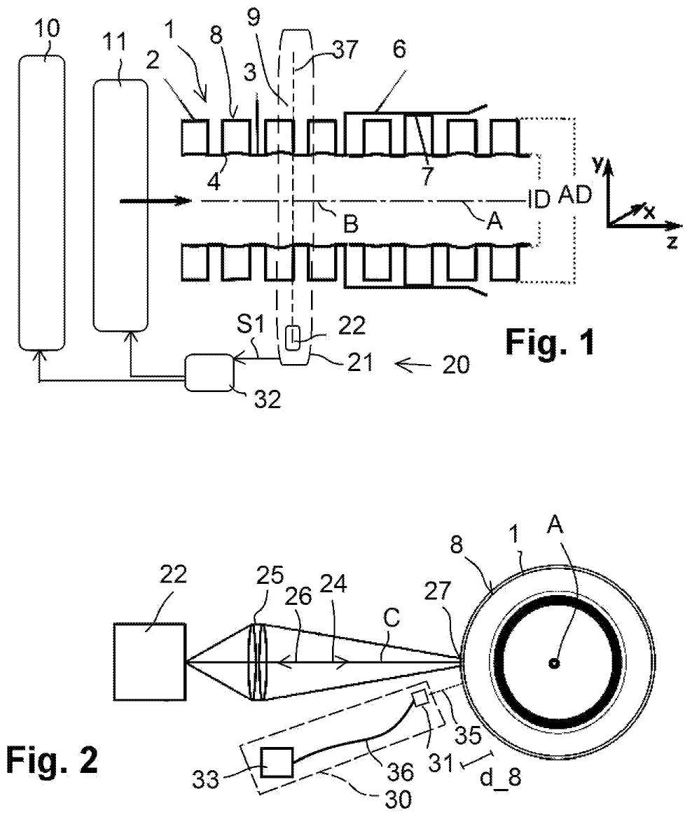

FIG. 1 a corrugated pipe in a longitudinal section view and its arrangement in a THz measuring device,

FIG. 2 the focusing of the THz beam onto a corrugated pipe in a radial section view;

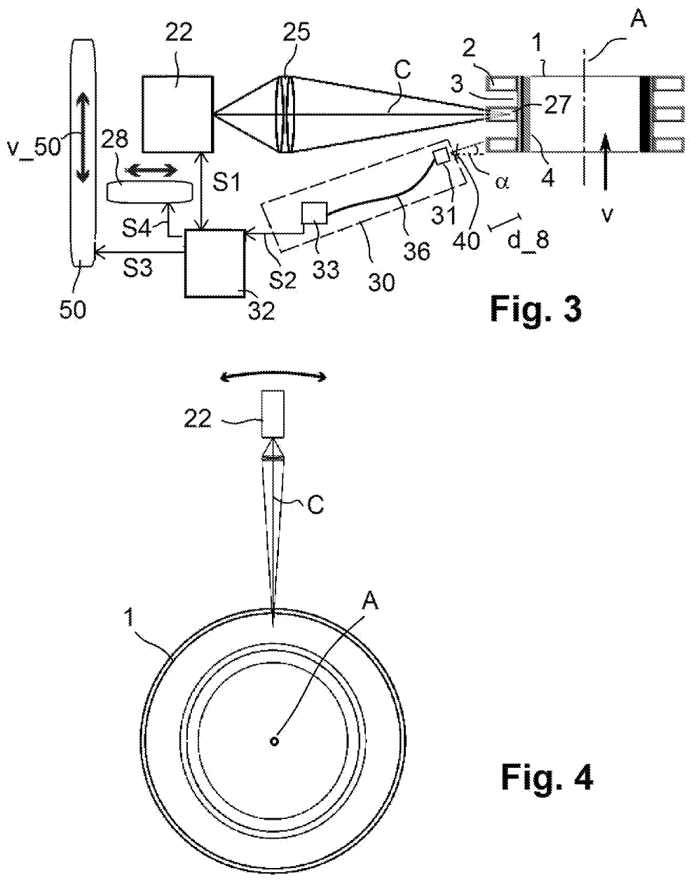

FIG. 3 a representation corresponding to FIG. 2 in a longitudinal section view or axial section view respectively;

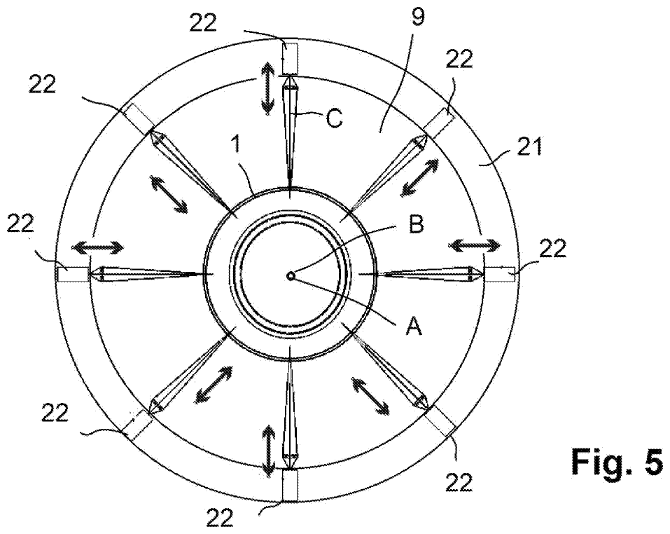

FIG. 4 a reversing adjustment of the THz transceiver for measuring the full circumference; and

FIG. 5 the arrangement of a plurality of THz transceivers around the corrugated pipe.

According to FIG. 1, a corrugated pipe 1 comprises a longitudinal axis A (axis of symmetry) which extends in the z direction or longitudinal direction respectively. In the longitudinal direction or, respectively Z direction waves 2 and troughs 3 each in-between the waves 2 are formed. The designs shown here are, in particular, corrugated pipes 1 with ring-shaped waves 2; in principle, however, also helical (coiling, spiral) waves may be formed also.

Thus, the corrugated pipe 1 comprises as structures waves 2 and troughs, and, advantageously, additionally exterior sleeves (bells) 6 and fittings (spigot, interior sleeves) 7. The fitting 7 serves, in particular, as ring seal receptacle, i.e., in particular, for accommodating ring seals, and has a wider exterior diameter AD_7 compared to the waves (crest, crown). The exterior sleeve 6 serves, in particular, for laying or affixing the corrugated pipe 1.

In the designs shown here, advantageously, a consistent inner tube 4 is formed through which fluids are guided without being swirled directly at the waves 2 and troughs 3. In principle, however, designs of corrugated pipes 1 without consistent inner tube 4 are possible also, in particular, for accommodating cables and lines inside.

The corrugated pipe 1 is made of plastics, in particular, a thermoplastic plastic material, and is initially formed continuously, e.g., by an extruder 10 and a subsequent wave-shape forming corrugator 11. Upon being manufactured the corrugated pipe 1 is guided in the Z direction through a THz measuring device 20 and measured continuously online. The THz measuring device 20 comprises e.g., a tubular housing 21 with an axis of symmetry B so that the corrugated pipe 1 is guided with its longitudinal axis A along the axis of symmetry B of the THz measuring device 20. At the housing 21 one or more THz transceiver(s) 22 is/are provided and each aligned radially inwards, i.e., towards the axis of symmetry B, as shown e.g., also in FIG. 5.

The one or the plurality of THz transceivers 22 each emit a THz transmission beam 24 along their optical axis C which is aligned towards the axis of symmetry B, i.e., stands perpendicular towards the structures of the corrugated pipe 1. The THz transmission beam 24 is focused by an optical arrangement 25, in particular, one or more lenses 25, onto a circular or elliptic focal point 27. The lens 25 may be made e.g., from silicon or plastics.

For measuring the individual components of the corrugated pipe 1 the focal point 27 can be adjusted in the direction of the optical axis C or, respectively, in a radial direction so that the focal point 27 always lies on the boundary surfaces or, respectively, areas to be measured. According to the embodiment shown here the focal length is fixed. Thus, a measuring distance MT of the focal point 27 along the optical axis C is set as a distance of the focal point 27 from the axis of symmetry B or, respectively, the longitudinal axis A.

The adjustment of the focal point 27, if provided, happens by means of a focusing means 28 which adjusts the THz transceiver 22 together with the optical arrangement 25 along the optical axis C, i.e., in the XY plane in a radial direction to the axis of symmetry B.

The THz transceivers 22 adjusts to measure the exterior diameters AD of the waves 2 as well as the interior diameter ID of the inner pipe 4, further also the layer thicknesses of the corrugated pipe 1 in both the waves 2 and the troughs 3. Thus, the inner tube 4 e.g., may be formed in multiple layers, where in the case of materials with different refraction indexes layer thicknesses of the individual layers can be measured.

The determination of each structure in the xy measuring plane, to adjust a suitable measuring distance MT of the focal point 27 from the axis of symmetry, happens via a detecting means 30 which, therefore, performs a pre-measurement. The detecting means 30 is designed as an optical means, in particular, including a laser, e.g., line laser, or even as a radar sensor and detects a distance d_8 of the exterior surface 8 of the corrugated pipe 1 in the xy measuring plane.

A controller device 32 of the THz measuring device 20 receives a measuring signal S2 from the detecting means 30 and determines from the distance d_8 determined by the detecting means 30 which structure of the corrugated pipe 1, i.e. a wave 2, a trough 3, or a sleeve 6, is present. Thus, in the embodiment shown by way of example in FIG. 1, the detecting means 30 can detect e.g., the sleeve 6 from outside, however, not the fitting 7 lying inside.

Advantageously, the detecting means 30 is dimensioned such that a laser beam is periodically or continuously in the Z direction. To that end, the detecting means 30 can include a detector head 31 to which e.g., an optical fiber 36 from a laser 33 is guided, and include an adjustable mirror, e.g. as rotating mirror 40, for adjustment, which, therefore, deflects the laser beam in the Z direction, and receives the reflected laser beams again for the purpose of laser distance metering (Lidar) and determines distances there from.

Thus, the method according to the invention includes the following steps:

The corrugated pipe 1 as test object is guided along the axis of symmetry B of the THz measuring device 20—step ST1,

in a pre-measurement, a distance of the exterior surface of the corrugated pipe 1 is determined by means of the detecting means 30—step ST2,

from the distance determined, the structure is determined respectively existing in the measuring plane 37 of the THz transceiver 22, i.e. e.g., wave or trough, fitting, exterior sleeve—step ST3

optionally: the transceiver or, respectively, the plurality of transceivers 22 may each be adjusted along their optical axis C such that the respective focal point 27 is suitably positioned on a surface to be measured, in particular, a boundary surface, each to be determined, of the structure; to that end, the controller device 32 controls the focusing means 28 via actuating signals S4—step ST4 according to one embodiment; THz measurement with emission of the THz transmission beam 24 and reception of the reflected THz beams reflected from boundary surfaces of the corrugated pipe 1—step ST5,

determination of distances and layer thicknesses from the THz measurement—step ST6,

comparison of the determined distances and layer thicknesses with reference values and determination as to whether there is an error—ST7

where required, displaying the error and/or controlling the extruder 10 and/or corrugator 11 for regulating and correcting the determined distances and layer thicknesses—step St8

Thus, when positioning the sleeve 6 in FIG. 1, the focal point 27 can initially be directed to e.g., the sleeve 6 and e.g., at this measuring position the adjacent surface of the fitting 7 can also be measured, and subsequently, the transceiver 22 can be adjusted radially along the optical axis C to measure the inner tube 4 lying beneath.

According to FIG. 4, during the THz measuring the THz transceiver 2 may be guided reversing or rotating respectively around the corrugated pipe 1 so that, provided that the rotational speed or rotational speed respectively of the THz transceiver 22 is sufficient, it is possible to measure the entire circumference. This may be provided together with the arrangement of a plurality of THz transceivers 22 according to FIG. 5.

A further advantageous embodiment takes into consideration that, in particular, at higher transport velocities v of the corrugated pipe 1 along the Z axis the fully circumferential measurement is too time consuming, in particular, with successive focusing on the wave 2 and the inner tube 4 lying beneath it, and, potentially, also with the additional reversion around the corrugated pipe 1.

Thus, according to this embodiment, as shown in FIG. 3, the THz measuring device 20 may comprise a slide 50 adjustable in the Z direction or, respectively, along the longitudinal axis A or axis of symmetry B on which the THz transceiver or transceivers 22, advantageously also the detecting means is/are accommodated. The slide 50 moves at a transport velocity v_50 along the Z direction so that during these adjustment periods a longer measuring time remains for the adjustment of the THz transceiver or transceivers 22, both in the direction of the optical axis C and in the circumferential direction. Hereby, the transport velocity v_50 may, in particular, correspond to the transport velocity v of the corrugated pipe 1.

Thus, in such a method, additional steps Schritt ST2 through ST5 provide for the adjustment of the slide 50 in the Z direction in that, preferably, the controller device 32 controls the slide 50 by means of actuating signals S3.

Subsequently, the direct measuring values of the distances and layer thicknesses can be used to determine indirectly derived characteristics values and preferably compared with comparison values, e.g., the inner roughness, further, a measuring report including statistically evaluated measuring data may be generated.

### LIST OF REFERENCE NUMERALS

1 corrugated pipe
2 wave (crest, crown)
3 trough (valley)
4 inner tube
6 sleeve (external sleeve, bell)
7 fitting, spigot
8 exterior surface of the corrugated pipe 1, for detection by the detecting means 30
9 measuring space
10 extruder
11 corrugator
THz measuring device
21 housing of the measuring device, measuring tube
22 THz transceiver
24 THz transmission beam
optical arrangement, in particular, lens
26 THz reflection beam
27 focal point, in particular, circular or elliptic
28 focusing device for adjusting the transceiver 22
30 detecting means, in particular, optical detecting means, e.g., laser distance meter or lidar
31 detecting head of the detecting means 30, for positioning in the measuring space above the corrugated pipe 1
32 controller device
33 laser
35 laser beam, deflected by rotating mirror 40
36 optical fiber
37 XY measuring plane
40 rotating mirror
50 slide, moving in the Z direction
A longitudinal axis of the corrugated pipe 1
B axis of symmetry of the measuring means 22 and housing 21
C optical axis of the THz transceiver 22, extending in the XY plane
ID interior diameter of the corrugated pipe 1
AD exterior diameter of the corrugated pipe 1
AD_7 exterior diameter on the fitting 7
AD_6 exterior diameter on the sleeve 6
v adjustment speed of the corrugated pipe 1
v_50 adjustment speed of the slide 50
X, Y, Z coordinates, with
Z adjustment direction/symmetry direction perpendicular to the XY plane
S1 measuring signals of the THz transceiver 22
S2 detection signal
S3 adjustment signal at slide 50
S4 actuating signal at focusing means 28
d_8 distance of the exterior surface
MT measuring distance, distance of the focal point 27 from the axist of symmetry B or longitudinal axis A
a picot angle of the detecting means
ST1-ST8 steps of the method

1-24. (canceled)

25. Terahertz (THz) measuring device for measuring a corrugated pipe, the THz measuring device comprising:
a housing including a measuring space for accommodating a corrugated pipe,
at least one THz transceiver for emitting a THz transmission beam along an optical axis into the measuring space and detecting a reflected THz beam,
a controller device adapted to receive measuring signals of said at least one THz transceiver,
a detecting means adapted to determine a distance and/or a position of an exterior surface of an accommodated corrugated pipe and to put out a detection signal to the controller device,
an optical arrangement by means of which the THz transmission beam emitted from the THz transceiver is focused onto a focal point formed at a measuring distance,
the controller device being adapted to
determine a structure of the accommodated corrugated pipe in a measuring plane from the positions or distances of the exterior surface of an accommodated corrugated pipe communicated in the detection signals, and
determine distances and/or layer thicknesses of a corrugated pipe from the measuring signals.

26. THz measuring device of claim 25, wherein the measuring distance of the focal point is static along the optical axis, in particular, at a fixed distance of the optical arrangement to the THz transceiver.

27. THz measuring device of claim 25, further comprising a focusing means for focusing the THz transmission beam and/or for adjusting the measuring distance of the focal point of the THz transmission beam along the optical axis, the controller device further being adapted to control the focusing means for adjusting the focal point of the at least one THz transceiver.

28. THz measuring device of claim 27, wherein the focusing means is configured to adjust the measuring distance of the focal point along the optical axis by adjusting the THz transceiver together with the optical arrangement, while having a fixed distance of the optical arrangement to the THz transceiver.

29. THz measuring device of claim 28, wherein the controller device is adapted to control the focusing means depending on the determined structure to set one or more measuring distances, e.g. in the case of a wave, an outer measuring distance for an exterior measurement on the determined exterior surface and at least one inner measuring distance for an interior measurement on an inner tube, and in the case of a trough, a measuring distance for a measurement on the inner tube.

30. THz measuring device of claim 25, wherein the controller device is adapted to detect, as structure of an accommodated corrugated pipe in the measuring plane, at least one of the following elements:
a wave,
a trough,
a fitting, in particular, as receptacle of a ring seal, and
an external sleeve.

31. THz measuring device of claim 25, wherein the controller device is adapted to determine, from said one or more measurements of the THz transceiver, at least one of the following measuring values:
an exterior diameter on a wave and/or on a fitting and/or on a sleeve,
an interior diameter of a trough and/or a wave and/or a fitting and/or a sleeve, wall thicknesses of an exterior wall of the wave and/or an inner pipe, and
thicknesses of an air gap of a wave between the inner tube and the exterior wall.

32. THz measuring device of claim 25, wherein the controller device is adapted to subsequently determine from the measuring values further dimension values or characteristics of the corrugated pipe, in particular, an inner roughness as difference or distinction between the inner diameters at various structure positions of the corrugated pipe.

33. THz measuring device of claim 25, wherein the detecting means comprises a laser, in particular, a line laser, and/or a radar sensor for measuring the distance of the exterior surface.

34. THz measuring device of claim 33, wherein the detecting means comprises a detector head which is adapted for a variable output of a laser beam or line laser at a pivot angle along the axis of symmetry, e.g., via a pivoting or rotating mirror.

35. THz measuring device of claim 25, wherein a plurality of THz transceivers are arranged on the housing in the circumferential direction around the axis of symmetry of the measuring space, the optical axes of said plurality of THz transceivers being aligned towards the measuring space or the axis of symmetry of the measuring space, preferably in a common measuring plane.

36. THz measuring device of claim 25, wherein measuring at least one THz transceiver is arranged on the housing reversing or rotating in the circumferential direction around the measuring space, so as to measure the entire circumference of an accommodated corrugated pipe, preferably in the measuring plane or helical around the measuring space.

37. THz measuring device of claim 25, further comprising a slide adjustable along a transport direction and/or axis of symmetry, said at least one THz transceiver, and preferably the detecting means too, is accommodated at the slide, for longitudinal adjustment of the slide when measuring a corrugated pipe at a transport velocity, in particular, the transport velocity of the corrugated pipe, in particular, for periodic adjustment of the slide in repeated adjustment maneuvers.

38. A THz measuring method for measuring a corrugated pipe, in particular, a corrugated pipe made of a plastic material, including at least the following steps:
transporting a corrugated pipe comprising waves and troughs formed in-between the waves in a transport direction through a measuring plane in a measuring space of a THz measuring device,
pre-measuring by means of a detecting means which continuously determines a position or a distance of an exterior surface of the corrugated pipe,
determining a structure of the corrugated pipe in the measuring plane from the determined position or the determined distance, THz measurement involving emitting a THz transmission beams along the optical axis, focusing onto the focal point and detecting a reflected THz beam, and
determining at least one distance of a boundary surface and/or at least one layer thickness of the corrugated pipe from the THz measurement.

39. The method of claim 38, wherein the measuring plane lies perpendicular to the conveying direction and/or perpendicular to a longitudinal axis of the corrugated pipe and/or perpendicular to an axis of symmetry of the THz measuring device.

40. The method of claim 38, wherein the following is determined as structure in the measuring plane: a wave, a trough, a sleeve or a fitting of the corrugated pipe, where, subsequently, the measuring distance of the focal point of the THz transmission beam is adjusted to one or more boundary surfaces of the determined structure.

41. The method of claim 40, wherein one or more of the following determinations are made: upon detection of the structure of a wave, both a distance and/or a layer thickness of an exterior wall of the wave and a distance and/or a layer thickness of an inner surface, e.g. the inner pipe of the wave are determined, upon detection of the structure of a trough, a distance and/or a layer thickness of an inner surface, e.g. the inner pipe of the wave is determined, upon detection of the structure of a fitting, a distance and/or a layer thickness of both an exterior layer of the fitting and an inner layer, e.g., of the inner pipe, of the fitting is determined, and/or upon detection of the structure of an exterior sleeve distance and/or a layer thickness of the exterior sleeve and further distances and/or layer thicknesses below the exterior sleeve of provided structures are determined, indirect characteristics, e.g., an inner roughness, are determined from determined distances or layer thicknesses.

42. The method of claim 38, wherein after determination of the structure, follows the step of adjusting a focal point of at least one THz transceiver along its optical axis to a measuring distance depending on the determined structure of the corrugated pipe in the measuring plane.

43. The method of claim 42, wherein for adjusting the measuring distance along the optical axis a distance of an optical arrangement, e.g., lens, provided for focusing the transmission beam of the THz transceiver remains fixed, and the THz transceiver is adjusted together with the optical arrangement.

44. The method of claim 38, wherein the at least one THz transceiver reverses or rotates circumferentially around the corrugated pipe in the circumferential direction, so as to measure the entire circumference of the corrugated pipe.

45. The method of claim 38, wherein upon pre-measuring and/or THz measuring, the at least one THz transceiver is transported along cyclically in the longitudinal direction or conveying direction of the corrugated pipe, e.g., by means of a slide, for measuring the detected structure of the corrugated pipe.

46. The method of claim 38, wherein the determined distances and layer thicknesses from the THz measurement and/or indirect characteristics determined there from are compared with reference values and it is determined whether there is an error, optionally with displaying the error or output of a control signal for a manufacturing process.
